(19) United States
(12) Patent Application Publication
(10) Pub. No.: US 2025/0348128 A1
(43) Pub. Date: Nov. 13, 2025

(54) SYSTEM, CONTROL METHOD, AND NON-TRANSITORY RECORDING MEDIUM

(71) Applicant: Hidemasa Morimoto, KANAGAWA (JP)

(72) Inventor: Hidemasa Morimoto, KANAGAWA (JP)

(73) Assignee: Ricoh Company, Ltd., Tokyo (JP)

(21) Appl. No.: 19/188,465

(22) Filed: Apr. 24, 2025

(30) Foreign Application Priority Data
May 9, 2024 (JP) 2024-076558

(51) Int. Cl. G06F 1/3228; G06F 1/3234

(52) U.S. Cl. CPC G06F 1/3228; G06F 1/3284

(57) ABSTRACT

A system includes an information processing apparatus and an apparatus to communicate with the information processing apparatus through a network. The information processing apparatus includes circuitry that inputs user information on an individual user on a day on which a usage frequency of the apparatus by the user is to be inferred into a usage frequency model that has learned a correspondence between the user information and the usage frequency of the apparatus, to infer the usage frequency of the apparatus on the day and determines a power-saving mode transition time based on the inferred usage frequency of the apparatus. The apparatus includes another circuitry that transitions to a power-saving mode when a time during which the apparatus is not used exceeds the power-saving mode transition time acquired from the information processing apparatus.

### CROSS-REFERENCE TO RELATED APPLICATION

This patent application is based on and claims priority pursuant to 35 U.S.C. § 119(a) to Japanese Patent Application No. 2024-076558, filed on May 9, 2024, in the Japan Patent Office, the entire disclosure of which is hereby incorporated by reference herein.

### BACKGROUND

### Technical Field

The present disclosure relates to a system, a control method, and a non-transitory recording medium.

### Related Art

Apparatuses such as image forming apparatuses have the function of transitioning to power-saving mode when the time during which the apparatuses are not in use exceeds a predetermined time. The predetermined time is referred to as a power-saving mode transition time. The image forming apparatuses transition to power-saving mode when the power-saving mode transition time elapses after the completion of the apparatus operation such as printing. Thus, the image forming apparatuses reduce power consumption.

Some techniques have been proposed to optimize the power-saving mode transition time.

### SUMMARY

The present disclosure described herein provides a system including an information processing apparatus and an apparatus to communicate with the information processing apparatus through a network. The information processing apparatus includes circuitry that inputs user information on an individual user on a day on which a usage frequency of the apparatus by the user is to be inferred into a usage frequency model that has learned a correspondence between the user information and the usage frequency of the apparatus, to infer the usage frequency of the apparatus on the day and determines a power-saving mode transition time based on the inferred usage frequency of the apparatus. The apparatus includes another circuitry that transitions to a power-saving mode when a time during which the apparatus is not used exceeds the power-saving mode transition time acquired from the information processing apparatus.

The present disclosure described herein provides a control method including inputting and determining. The inputting includes inputting user information on an individual user on a day on which a usage frequency of an apparatus by the user is to be inferred into a usage frequency model that has learned a correspondence between the user information and the usage frequency of the apparatus, to infer the usage frequency of the apparatus on the day. The apparatus communicates with an information processing apparatus through a network. The determining includes determining a power-saving mode transition time based on the inferred usage frequency of the apparatus. The apparatus transitions to a power-saving mode when a time during which the apparatus is not used exceeds the power-saving mode transition time acquired from the information processing apparatus.

The present disclosure described herein provides a non-transitory recording medium storing a plurality of instructions which, when executed by one or more processors of an information processing apparatus, causes the one or more processors to perform a method. The method includes inputting and determining. The inputting includes inputting user information on an individual user on a day on which a usage frequency of an apparatus by the user is to be inferred into a usage frequency model that has learned a correspondence between the user information and the usage frequency of the apparatus, to infer the usage frequency of the apparatus on the day. The apparatus communicates with the information processing apparatus through a network. The determining includes determining a power-saving mode transition time based on the inferred usage frequency of the apparatus. The apparatus transitions to a power-saving mode when a time during which the apparatus is not used exceeds the power-saving mode transition time acquired from the information processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating data on operating frequency for each day of the week and per hour when almost all employees are at the office (or when a predetermined number or more of employees are at the office);

FIG. 2 is a diagram illustrating the operating frequency when a certain percentage or more of employees are at the office in a remote work environment;

FIG. 3 is a diagram illustrating the operating frequency of an image forming apparatus when only Type B employees among all the employees are at the office;

FIG. 4 is a diagram illustrating a difference between power consumption according to a comparative example and ideal power consumption when only Type B employees are at the office;

FIG. 5 is a diagram illustrating the usage frequency of an image forming apparatus when only Type D employees are at the office;

FIG. 6 is a diagram illustrating a difference in power consumption when the actual operating frequency is high in a case where the power-saving mode transition time is set to be medium according to a comparative example;

FIG. 7 is a diagram illustrating a difference between power consumption when the actual operating frequency is high and ideal power consumption when the operating frequency is high in a case where the power-saving mode transition time is set to be medium according to a comparative example;

FIG. 8 is a diagram illustrating a configuration of an apparatus system;

FIG. 9 is a diagram illustrating a hardware configuration of an image forming apparatus;

FIG. 10 is a diagram illustrating a hardware configuration of a machine learning server, a data server, or a general-purpose computer;

FIG. 11 is a block diagram illustrating a functional configuration of a data server, a machine learning server, and an image forming apparatus;

FIG. 12 is a diagram illustrating a transition time determination table to which a transition time determination unit refers;

FIG. 13 is a diagram illustrating a transition time setting screen displayed by an image forming apparatus;

FIG. 14 is a conceptual diagram of a usage frequency model generated by a machine learning unit;

FIG. 15 is a schematic diagram illustrating a learning method;

FIG. 16 is a schematic diagram illustrating inference by a usage frequency model;

FIG. 17 is a diagram illustrating a printing frequency inferred by a usage frequency model for an employee;

FIG. 18 is a diagram illustrating an operating frequency generated from printing frequencies inferred for multiple employees;

FIG. 19 is a sequence diagram illustrating a process in which an apparatus system generates a usage frequency model; and

FIG. 20 is a sequence diagram illustrating a process in which the machine learning server outputs a power-saving mode transition time per hour using a generated usage frequency model.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

An apparatus and a control method performed by the apparatus are described below.

### Supplemental Description of Power-Saving Control

The power consumption is reduced by learning the operating status of an image forming apparatus and optimizing the time it takes for the image forming apparatus to transition to power-saving mode, which may be referred to as a power-saving mode transition time in the following description. When typical image forming apparatuses are in power-saving mode during non-operation, power consumption can be reduced. The longer the image forming apparatuses remain in power-saving mode, the greater the reduction in power consumption. By shortening the power-saving mode transition time, the image forming apparatuses can quickly transition to power-saving mode and increase the time for maintaining power-saving mode accordingly, which is effective in reducing power consumption.

However, returning from power-saving mode needs a larger amount of start-up power than in standby state in which the functions of the image forming apparatuses can be used. For this reason, in a situation where the users frequently use the image forming apparatuses, the power consumption can be more easily reduced by keeping the image forming apparatuses in standby state than by transitioning the image forming apparatuses to power-saving mode.

Thus, controlling whether to transition to power-saving mode according to the operating status is effective in reducing the overall power consumption. The operating status is the operating frequency. The power-saving mode transition time is optimized according to the operating frequency. For example, in typical control, the power-saving mode transition time is shortened during periods of low operating frequency whereas the power-saving mode transition time is lengthened (the standby state is maintained) during periods of high operating frequency so as not to cause start-up power when returning from the power-saving mode.

For example, according to a comparative example, the power-saving mode transition time is set based on the operating status of an image forming apparatus for each day of the week. However, in this example, the usage frequency for each day of the week and per hour is used for optimization on the assumption that almost all employees are at the office or that a predetermined number or more of employees are at the office. In the following description, data on the operating frequency when all employees or a predetermined number or more of employees are at the office or workplace is referred to as “group data.”

On the other hand, in companies that utilize remote work in a large amount, which has become active in recent years, individuals can decide whether to work at the office or remotely and it is difficult to appropriately optimize the power-saving mode transition time on the assumption that a predetermined number or more of employees are at the office. This is described below with reference to the drawings.

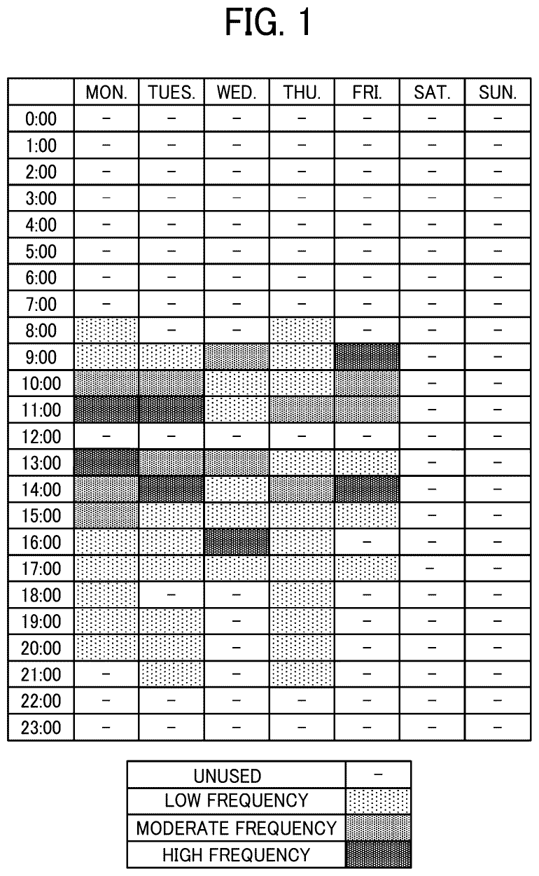

FIG. 1 illustrates data on operating frequency for each day of the week and per hour when almost all employees are at the office (or when a predetermined number or more of employees are at the office). The usage frequency is the frequency at which a single user uses an image forming apparatus. The operating frequency is the frequency at which the image forming apparatus operates. Even when the usage frequency of each user is low, the operating frequency may increase when many users are at the office.

The operating frequency or the usage frequency is classified into four stages such as unused, low frequency, moderate frequency, and high frequency in ascending order. During periods of unused, which refer to the times when the image forming apparatus is not in use, the image forming apparatus remains in power-saving mode for a longer duration by shortening the power-saving mode transition time. Thus, the power consumption can be reduced most. During periods of high frequency, which refer to the times when the image forming apparatus operates at a high frequency, the image forming apparatus is used immediately after transitioning to the power-saving mode. For this reason, the power-saving mode transition time is set to be long, and the power consumption is the highest.

As described above, typically, the power-saving mode transition time is determined based on the operating frequency (in other words, group data) of all employees, instead of individual employees, for each day of the week and each hour. In a situation where all employees are at the office almost every day before remote work becomes widespread and group data indicate similar tendencies, the operating frequency is similar on the same day every week. Therefore, it is effective to optimize the power-saving mode transition time based on the group data and reduce the power consumption.

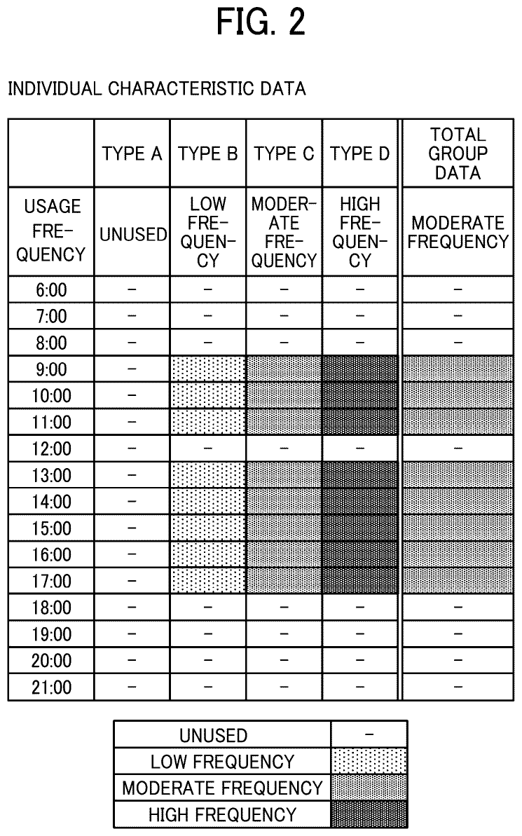

However, in a remote work environment, which refers to an environment where remote work is permitted, individuals can decide whether to work at the office or remotely. Therefore, similar group data is not acquired on the same day every week. A description is given below with reference to FIG. 2.

FIG. 2 is a diagram illustrating the operating frequency when a certain percentage or more of employees are at the office in a remote work environment. The certain percentage is, for example, 80% or more of all the employees. The operating frequency when 80% or more of the employees are at the office may be substantially constant regardless of the day of the week or the time, although there may be errors. For the sake of description, the employees are classified into Types A to D from the viewpoint of the usage frequency in the following description. Types A to D are kept during working hours regardless of time.

In FIG. 2, since Type A employees do not use the image forming apparatus, the usage frequency is “unused.” Type B employees use the image forming apparatus at a low frequency. Type C employees use the image forming apparatus at a moderate frequency. Type D employees use the image forming apparatus at a high frequency.

For the sake of simplicity, the number of employees in each type (A, B, C, and D) is equal. For example, the number of Type A employees is 10, the number of Type B employees is 10, the number of Type C employees is 10, and the number of Type D employees is 10. The group data indicates a total value of Types A, B, C, and D employees. In FIG. 2, an average is taken, and the operating frequency of the group data is defined as a moderate frequency. The following description is based on this assumption.

In a remote work environment, a certain number or more of employees (for example, 80% or more of all employees) are not always at the office. The number of employees may be, for example, 50% or 60% depending on the day. In this case, the reduction in the number of usage frequencies of the group data typically makes it difficult to optimize the power-saving mode transition time. In other words, the power-saving mode transition time optimized based on the group data may not reduce total power consumption.

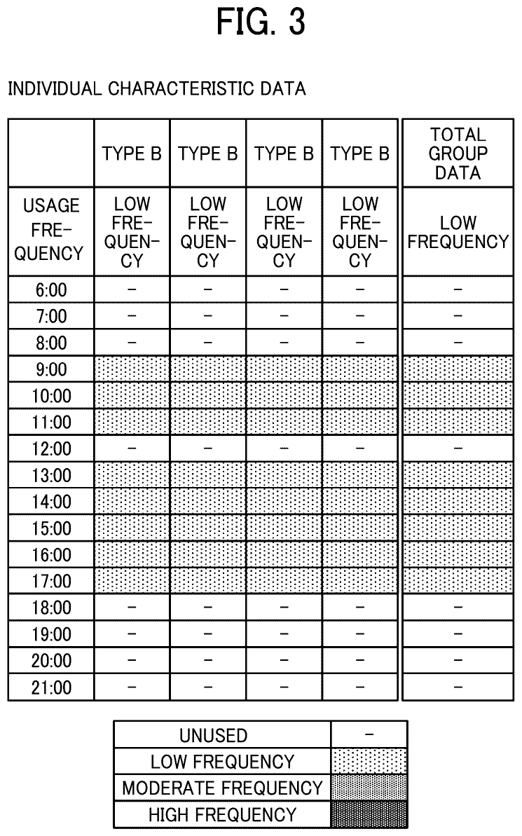

As illustrated in FIG. 3, there may be a situation where only Type B employees who use the image forming apparatus at a low frequency are at the office. FIG. 3 illustrates the operating frequency of the image forming apparatus when only Type B employees among all the employees are at the office. The usage frequency of Type B employees is low, and the total usage frequency (operating frequency) is also low. However, typically, the group data in a case where a certain number or more of employees, such as 80% of the employees, are at the office is used, and the operating frequency is moderate. Applying the power-saving mode transition time optimized based on the group data of the moderate frequency to a situation where only the employees who use the image forming apparatus at a low frequency are at the office makes it difficult to reduce the total power consumption.

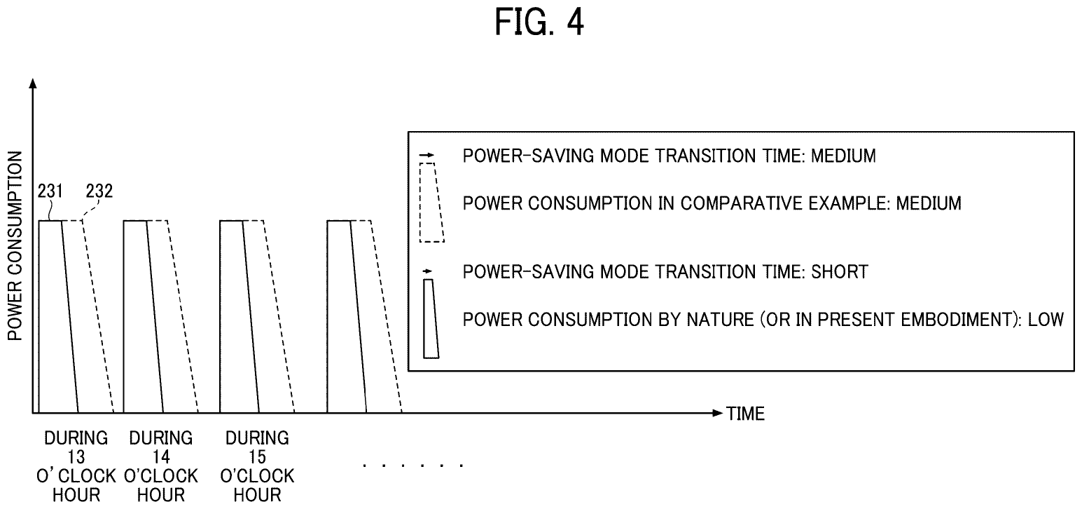

FIG. 4 is a diagram illustrating a difference between power consumption according to a comparative example and ideal power consumption when only Type B employees are at the office. In FIG. 4, the horizontal axis represents time, and the vertical axis represents power consumption. A dotted line 232 indicates power consumption according to the comparative example. A solid line 231 indicates ideal power consumption. The ideal power consumption is power consumption in the case of the power-saving mode transition time described in the present embodiment. A longer power-saving mode transition time increases power consumption. In other words, when the operating frequency is low, the power-saving mode transition time may be short, and the ideal power consumption is the sum of the solid lines. However, according to the comparative example, the power-saving mode transition time is determined based on the group data in a case where 80% or more of the employees are at the office, failing to cope with the individual attendance status, which refers to the status of employees coming to the office or workplace. The power-saving mode transition time is optimized for the moderate frequency and the power-saving mode transition time is also medium. Therefore, the power consumption is also medium. As described above, even in a situation where the power consumption can be ideally reduced, the power consumption is typically medium and cannot be reduced in some cases.

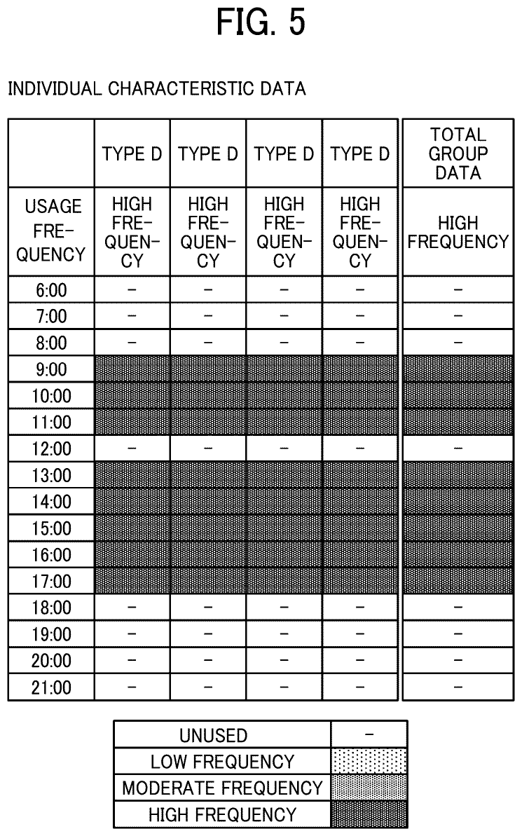

Another typical situation where reduction in power consumption fails is described below with reference to FIG. 5. FIG. 5 illustrates the usage frequency of the image forming apparatus when only Type D employees are at the office. Even when only a small number of employees, not a predetermined number of employees, are at the office, the operating frequency is high when only employees who use the image forming apparatus at a high frequency are at the office. Although the operating frequency of the image forming apparatus is high, the operating frequency is moderate in the comparative example because the group data in a case where a certain number of employees, such as 80%, are at the office is used. Applying the power-saving mode transition time optimized based on the group data of the moderate frequency to a situation where the employees who use the image forming apparatus at a high frequency are at the office makes it difficult to reduce the total power consumption.

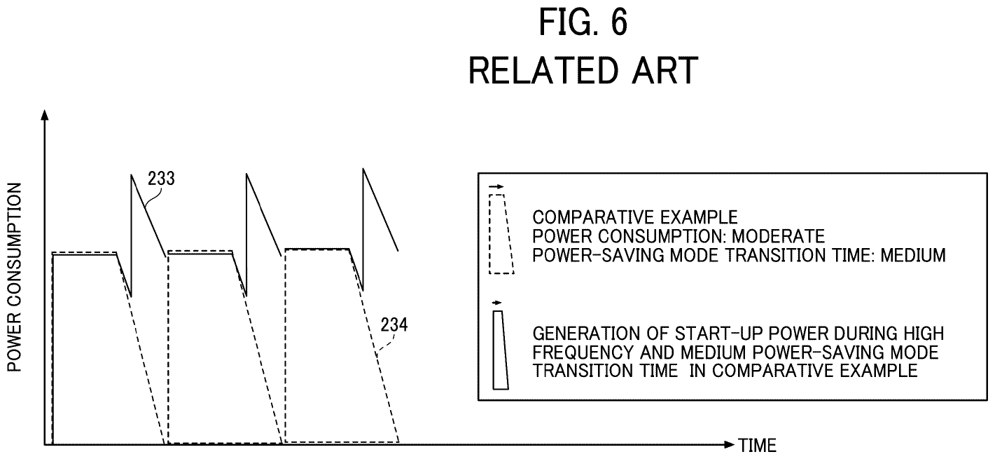

FIG. 6 is a diagram illustrating a difference in power consumption when the actual operating frequency is high in a case where the power-saving mode transition time is set to be medium according to a comparative example. The horizontal axis represents time, and the vertical axis represents power consumption. A dotted line 234 indicates power consumption according to the comparative example. A solid line 233 indicates actual power consumption. When the operating frequency is high, the image forming apparatus is continuously used. Therefore, even when the image forming apparatus transitions to power-saving mode, the image forming apparatus needs to immediately return and consume the start-up power. As illustrated in FIG. 6, even when the image forming apparatus is about to transition to power-saving mode, the start-up power (peak of the solid line 233) occurs. Since the start-up power of the image forming apparatus is large, the start-up power may cause extra power consumption.

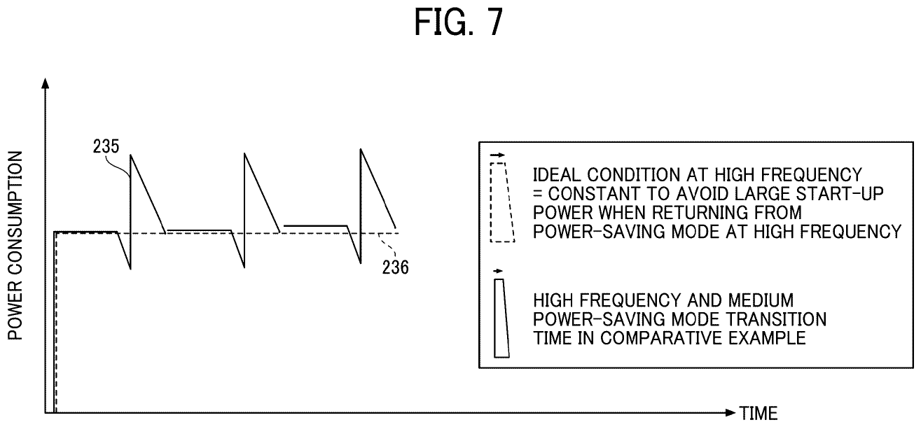

FIG. 7 illustrates a difference between power consumption when the actual operating frequency is high and ideal power consumption when the operating frequency is high in a case where the power-saving mode transition time is set to be medium according to a comparative example. A dotted line 236 indicates ideal power consumption when the operating frequency is high. A solid line 235 indicates power consumption when the power-saving mode transition time is set to be medium and the actual operation frequency is high. As indicated by the solid line 235, the start-up power increases the power consumption. As indicated by the dotted line 236, the power consumption is relatively low when the operating frequency is high and the image forming apparatus is kept in standby state without transitioning to power-saving mode.

As described above, in an environment such as a remote work environment where the individuals can decide whether to work at the office or remotely, the group data is completely different depending on the day of the week or the time. Therefore, optimizing the power-saving mode transition time based on the group data fails to cope with this situation and makes it difficult to reduce power consumption.

Using artificial intelligence (AI) technology to learn the relationships between the typical group data and the operating frequency can enable accurate updates to usage frequency for each day of the week and each hour illustrated in FIG. 2. However, in a situation where individuals can decide whether to work at the office or remotely, such as in a remote work environment, the tendency of the group data changes day by day, and therefore, the power-saving mode transition time set based on the group data may fail to reduce power consumption as appropriate.

Therefore, the method simply using AI to learn the group data fails to address unfavorable situations.

According to the present embodiment, the image forming apparatus learns the usage frequency using AI based on individual employee information instead of the group data to optimize the power-saving mode transition time and reduce the overall power consumption even in a remote work environment.

### Terms

The total power consumption is the sum of the reduction in power consumption for the transition to power-saving mode and the power consumption for the return from the power-saving mode. In other words, the total power consumption is the overall power consumption of the image forming apparatus.

The individual employee information is information on a single employee and is information on whether to use the image forming apparatus. The individual employee information does not include, for example, the date of birth of the employee. For example, the individual employee information includes the attendance status and meeting start time.

The usage frequency refers to how many times the image forming apparatus is used in a unit time. The unit time is not limited to one hour and may be a minute, two hours, a half day, or a day.

The power-saving mode transition time is a time during which it is determined that the image forming apparatus is determined to transition to power-saving mode because the image forming apparatus is not in use. In power-saving mode, power consumption is smaller than that in standby state. The power-saving mode may further include multiple states with different power consumption.

### System Configuration

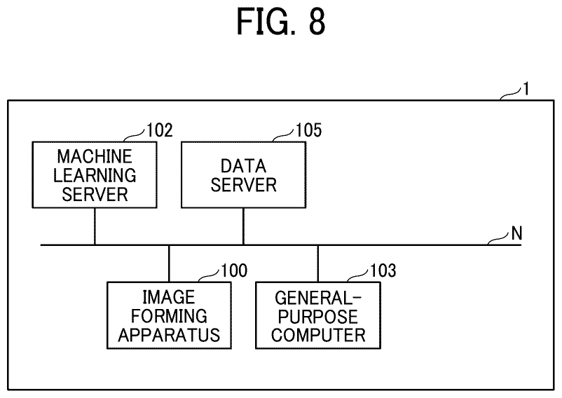

FIG. 8 is a diagram illustrating a configuration of an apparatus system 1. The apparatus system 1 includes an image forming apparatus 100, a machine learning server 102, a data server 105, and a general-purpose computer 103. These apparatuses are connected through a network N such as a local area network (LAN) and can communicate with each other. The general-purpose computer 103 may be connected to the network N as necessary and may not necessarily be included in the apparatus system 1.

The network connecting these components may be wired or wireless. The machine learning server 102 and the data server 105 may be on the cloud or on-premises. In a case where the machine learning server 102 and the data server 105 are on the cloud, the machine learning server 102 and the data server 105 may be connected to the image forming apparatus 100 through a wide-area network such as the Internet and can communicate with the image forming apparatus 100.

The image forming apparatus 100 is an example of an apparatus that transitions to power-saving mode. The image forming apparatus 100 is an apparatus that forms an image on a recording medium such as a sheet of paper. The image forming apparatus 100 may be referred to as, for example, a printer, a copier, a multifunction peripheral (M FP), a printing apparatus, or a facsimile machine.

The apparatus may be, for example, an interactive whiteboard or digital blackboard, a projector, a video conference terminal, digital signage, a drone, a robot, a telephone, a television receiver, a game console, a general-purpose individual computer (PC), a monitoring camera, or industrial equipment having a communication function, instead of the image forming apparatus. Examples of industrial equipment include medical equipment and agricultural equipment such as a cultivator.

The machine learning server 102 generates a usage frequency model for inferring the usage frequency for each period by performing machine learning on individual employee information. In other words, the machine learning server 102 is equipped with an AI function. The machine learning server 102 generates a usage frequency model for implementing the AI function. The machine learning server 102 can generate a usage frequency model 220 by performing machine learning using a part or all of the learning data acquired from the data server 105.

The machine learning server 102 may be a general-purpose information processing apparatus instead of a server. The data server 105 acquires learning data used for machine learning in the machine learning server 102 from, for example, the general-purpose computer 103, the image forming apparatus 100, or the schedule management server.

The learning data, which is described in detail later, includes a printing time of the image forming apparatus 100 for each employee, individual employee information, and meeting schedules indicating meeting start time. The data server 105 collects learning data and provides the learning data to the machine learning server 102.

The general-purpose computer 103 is, for example, a user terminal and transmits print data to the image forming apparatus 100. The data server 105 may acquire, for example, individual employee information from the general-purpose computer 103.

The image forming apparatus 100 acquires the power-saving mode transition time for each period generated by the machine learning server 102 at any time.

The data server 105 and the machine learning server 102 are present outside the image forming apparatus 100. Alternatively, the image forming apparatus 100 may have the functions of the data server 105 and the machine learning server 102.

### Hardware Configuration

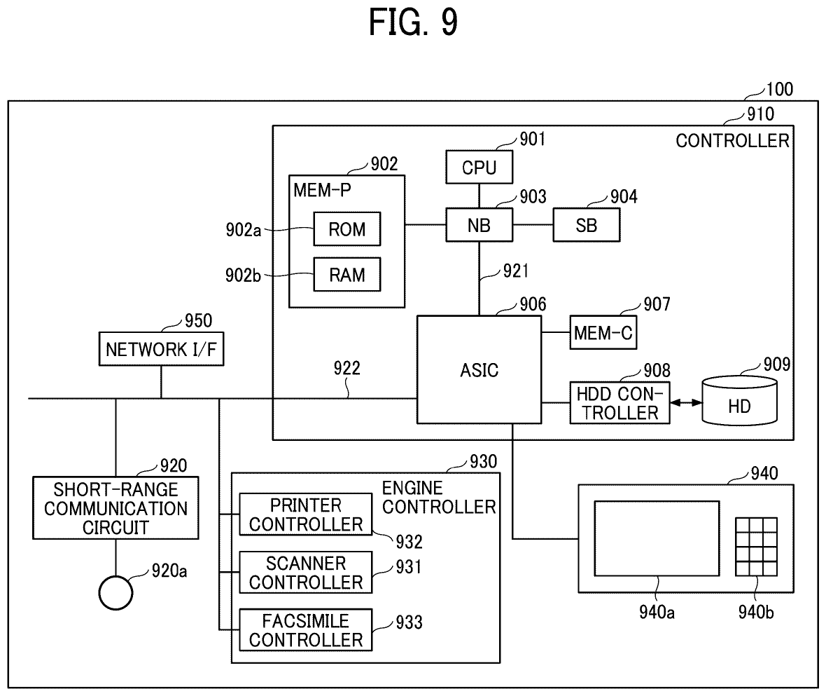

A hardware configuration of the image forming apparatus 100 included in the apparatus system 1 is described below with reference to FIG. 9. FIG. 9 is a diagram illustrating a hardware configuration of the image forming apparatus 100. As illustrated in FIG. 9, the image forming apparatus 100 includes a controller 910, a short-range communication circuit 920, an engine controller 930, a control panel 940, and a network interface (I/F) 950.

The controller 910 includes a central processing unit (CPU) 901 as a main processor of a computer, a system memory (MEM-P) 902, a north bridge (NB) 903, a south bridge (SB) 904, an application-specific integrated circuit (ASIC) 906, a local memory (MEM-C) 907 as a storage device, a hard disk drive (HDD) controller 908, and a hard disk (HD) 909 as a storage device. The NB 903 and the A SIC 906 are connected through an accelerated graphics port (AGP) bus 921.

Specifically, the CPU 901 controls the overall operation of the image forming apparatus 100.

The NB 903 connects the CPU 901 to the MEM-P 902, the SB 904, and the AGP bus 921. The NB 903 includes a peripheral component interconnect (PCI) master, an A GP target, and a memory controller that controls the reading or writing of data to or from the MEM-P 902.

The MEM-P 902 includes a read-only memory (ROM) 902a and a random-access memory (RAM) 902b. The ROM 902a is a storage memory for programs and data that implement various functions of the controller 910. The RAM 902b is used for deploying programs and data, as well as for rendering during memory printing. The programs stored in the RAM 902b may be stored and provided on a computer-readable recording media such as compact disc read-only memories (CD-ROM s), compact disc-recordables (CD-Rs), and digital versatile discs (DV Ds) in an installable or executable file format.

The SB 904 connects the NB 903 to a PCI device and a peripheral device. The A SIC 906 is an integrated circuit (IC) dedicated to image processing and includes hardware elements for image processing. The A SIC 906 serves as a bridge to connect the AGP bus 921, a PCI bus 922, the HDD controller 908, and the MEM-C 907 to each other. The ASIC 906 includes a PCI target, an AGP master, an arbiter (ARB) as a central processor of the ASIC 906, a memory controller that controls the MEM-C 907, multiple direct memory access controllers (DMACs), and a PCI unit. The DMACs convert coordinates of image data with, for example, a hardware logic to rotate an image based on the image data. The PCI unit transfers data between a scanner controller 931, a printer controller 932, and a facsimile controller 933 through the PCI bus 922. The ASIC 906 may have a universal serial bus (USB) interface, or the Institute of Electrical and Electronics Engineers 1394 (IEEE1394) interface.

The MEM-C 907 is a local memory that is used as a buffer for image data to be copied or a code buffer. The HD 909 is a storage device that accumulates image data, font data for printing, and form data. The HDD controller 908 controls the reading or writing of data to or from the HDD 909 under the control of the CPU 901. The AGP bus 921 is a bus interface for a graphics accelerator card, which is proposed to accelerate graphics processing. Direct access to the MEM-P 902 by high throughput can accelerate the graphics accelerator card.

The short-range communication circuit 920 is provided with a short-range communication antenna 920a. The short-range communication circuit 920 is a communication circuit in compliance with, for example, the near field communication (NFC) or BLUETOOTH.

The engine controller 930 includes the scanner controller 931, the printer controller 932, and the facsimile controller 933. The control panel 940 includes a panel display 940a such as a touch panel that displays the current settings or a selection screen and receives user input.

The control panel 940 further includes a hard key 940b that includes a numeric keypad and a start key. The numeric keypad receives assigned values of image forming parameters such as an image density parameter. The start key receives an instruction to start copying. The controller 910 controls the entire image forming apparatus 100. For example, the controller 910 controls rendering, communication, and input through the control panel 940. The scanner controller 931 or the printer controller 932 performs image processing such as error diffusion or gamma conversion.

The image forming apparatus 100 allows a document box function, a copier function, a printer function, and a facsimile function to be sequentially switched and selected using an application switch key on the control panel 940. The image forming apparatus 100 switches to document box mode when the document box function is selected, to coper mode when the copier function is selected, to printer mode when the printer function is selected, and to facsimile mode when the facsimile function is selected.

The network I/F 950 is an interface that enables data communication through the network N. The short-range communication circuit 920 and the network I/F 950 are electrically connected to the A SIC 906 through the PCI bus 922.

### Machine Learning Server 102, Data Server 105, or General-Purpose Computer 103

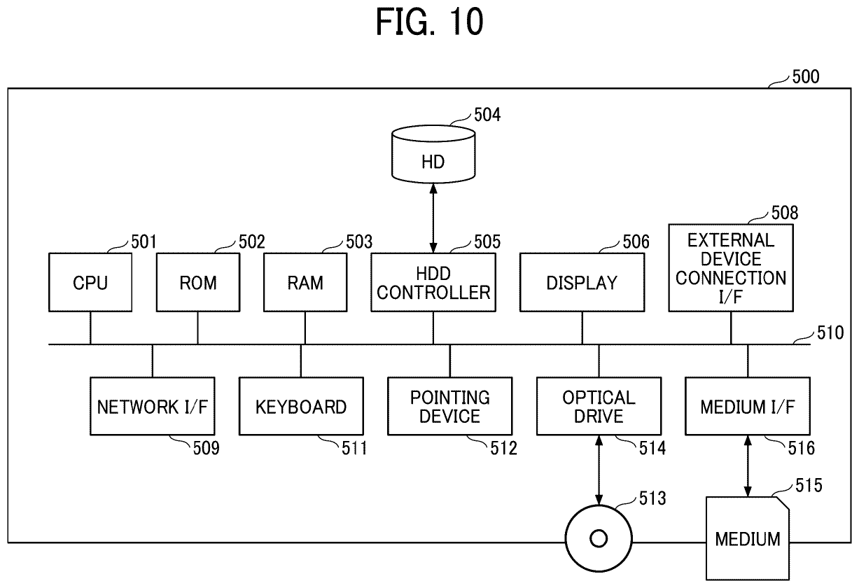

FIG. 10 is a diagram illustrating a hardware configuration of the machine learning server 102, the data server 105, or the general-purpose computer 103. As illustrated in FIG. 10, the machine learning server 102, the database server 105, or the general-purpose computer 103 is implemented by a computer 500. The computer 500 includes a CPU 501, a ROM 502, a RAM 503, an HD 504, an HDD controller 505, a display 506, an external device connection I/F 508, a network I/F 509, a bus line 510, a keyboard 511, a pointing device 512, an optical drive 514, and a medium I/F 516.

The CPU 501 controls the overall operation of the computer 500. The ROM 502 stores programs such as an initial program loader (IPL) to boot the CPU 501. The RAM 503 is used as a work area for the CPU 501. The HD 504 stores various kinds of data such as programs. The HDD controller 505 controls the reading or writing of various kinds of data to or from the HD 504 under the control of the CPU 501. The display 506 displays various information such as the cursor, menus, windows, text, or image data. The external device connection I/F 508 is an interface that connects the computer 500 to various external devices. In this case, the external devices include, for example, a USB memory stick and a printer.

The network I/F 509 is an interface that enables data communication through a network. The bus line 510 is, for example, an address bus or a data bus that electrically connects the components such as the CPU 501 illustrated in FIG. 10.

The keyboard 511 is a type of input device equipped with multiple keys used for entering characters, numbers, and various commands. The pointing device 512 is a type of input device that enables, for example, the selection and execution of various commands, the selection of processing targets, and the movement of the cursor. The optical drive 514 controls the reading or writing of various kinds of data to or from an optical recording medium 513, which is an example of a removable storage medium. The optical recording medium 513 may be, for example, a compact disc (CD), a DVD, or a Blu-ray™ disc. The medium I/F 516 controls the reading or writing (storage) of data to or from a recording medium 515 such as flash memory.

### Functions

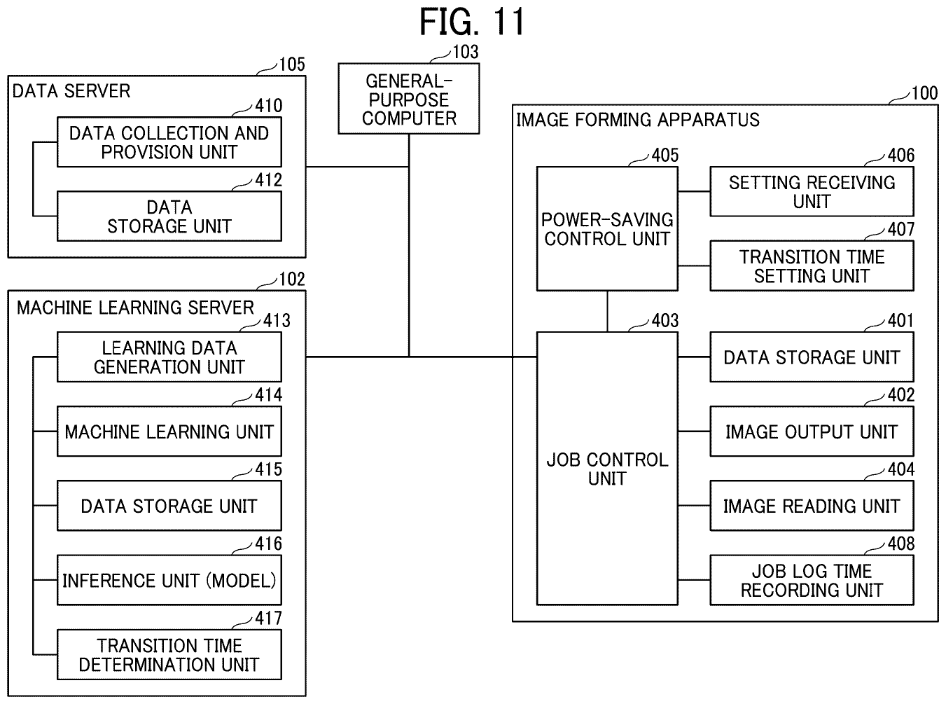

FIG. 11 is a block diagram illustrating a functional configuration of the data server 105, the machine learning server 102, and the image forming apparatus 100.

### Data Server 105

The data server 105 includes a data collection and provision unit 410 and a data storage unit 412. These functional units of the data server 105 are functions or means implemented by the CPU 501 executing commands included in one or more programs installed on the server 105. The programs are stored in the storage for each component, read into RAM, and executed by the CPU. For example, in the data server 105, the programs are stored on the HD 504, read into the RAM 503, and executed by the CPU 501.

The data collection and provision unit 410 collects and provides learning data for the machine learning server 102 to perform learning. The data collection and provision unit 410 collects the time at which a job such as printing or copying job is executed from a job log time recording unit 408 of the image forming apparatus 100 and the employee information such as individual attendance status managed by the data server 105. The data collection and provision unit 410 provides the collected time and employee information to the machine learning server 102.

The data storage unit 412 temporarily stores the learning data collected by the data collection and provision unit 410.

### Image Forming Apparatus 100

The image forming apparatus 100 includes a data storage unit 401, an image output unit 402, a job control unit 403, an image reading unit 404, a power-saving control unit 405, a setting receiving unit 406, a transition time setting unit 407, and the job log time recording unit 408. These functional units of the image forming apparatus 100 are functions or means implemented by the CPU 901 executing commands included in one or more programs installed on the image forming apparatus 100. The programs are stored on the HD 909, read into the RAM 902b, and executed by the CPU 901. A graphics processing unit (GPU) may be used in addition to the CPU 901.

The data storage unit 401 stores data such as print data, image data, and power-saving mode transition time, which the image forming apparatus 100 inputs and outputs, on the RAM 902b or the HD 909.

The image output unit 402 controls the engine controller 930 to perform, for example, copying, faxing, and printing of an image rendered by the A SIC 906.

The job control unit 403 executes basic functions of the image forming apparatus 100 such as copying, faxing, and printing based on user instruction. The job control unit 403 performs the transmission and reception of instructions or data between other software components as the job control unit 403 executes the basic functions.

The image reading unit 404 controls the scanner controller 931 to read a document and generate image data of the document when executing copying or scanning based on an instruction from the job control unit 403.

The transition time setting unit 407 acquires the power-saving mode transition time transmitted from the machine learning server 102. For example, the transition time setting unit 407 acquires the power-saving mode transition time per hour transmitted from the machine learning server 102. The transition time setting unit 407 transmits the power-saving mode transition time for each period to the power-saving control unit 405.

The power-saving control unit 405 performs control to transition to the power-saving mode when the time during which the image forming apparatus 100 is not used exceeds the power-saving mode transition time for each period acquired from the transition time setting unit 407, and control to return from power-saving mode when, for example, a print job is generated.

The setting receiving unit 406 receives the setting of the power-saving mode transition time manually set by the user. The user can select either the manual setting through the setting receiving unit 406 or the setting by the transition time setting unit 407. The power-saving control unit 405 performs the transition to power-saving mode based on the user setting (selection by the user).

The setting receiving unit 406 displays a setting screen on the control panel 940 of the image forming apparatus 100 and receives the user setting. Alternatively, the setting may be received by image forming apparatus control software installed on the general-purpose computer 103, and the general-purpose computer 103 may transmit the setting to the image forming apparatus 100.

The job log time recording unit 408 records the time when a job is executed, such as the printing time or copying time, for each employee. The time when a job is executed is the time when the employee uses the image forming apparatus 100.

### Machine Learning Server 102

The machine learning server 102 includes a learning data generation unit 413, a machine learning unit 414, a data storage unit 415, an inference unit 416, and a transition time determination unit 417. These functional units of the machine learning server 102 are functions or means implemented by the CPU 501 executing commands included in one or more programs installed on the machine learning server 102. The programs are stored on the HD 504, read into the RAM 503, and executed by the CPU 501. A GPU may be used in addition to the CPU 501.

The learning data generation unit 413 performs preprocessing of the learning data received from the data server 105. The preprocessing includes the removal of noise from the learning data such as an outlier and normalization. The learning data generation unit 413 also optimizes the learning data by performing format adjustments of the learning data to generate the usage frequency model 220.

The storage unit 415 records, for example, the learning data received from the data server 105, generated learning data, the usage frequency model 220 generated by the machine learning unit 414, or the output of the usage frequency model 220 on the RAM 503 or the HD 504.

The machine learning unit 414 generates the usage frequency model 220 that outputs the usage frequency for each time, using the learning data stored in the data storage unit 415 by the learning data generation unit 413 and an algorithm such as a neural network. The usage frequency model 220 generated by the machine learning unit 414 or a function using this model is referred to as the inference unit 416. The usage frequency model 220 may be generated for each employee.

The inference unit 416 infers the printing frequency per hour with the employee information as input data of the usage frequency model 220. The inference unit 416 acquires individual employee information and infers the printing frequency for each employee.

The transition time determination unit 417 combines the printing frequencies per hour inferred for each of the multiple employees. The transition time determination unit 417 determines the power-saving mode transition time based on the combined printing frequency. The power-saving mode transition time for each time may be referred to as “machine learning result data” in the following description.

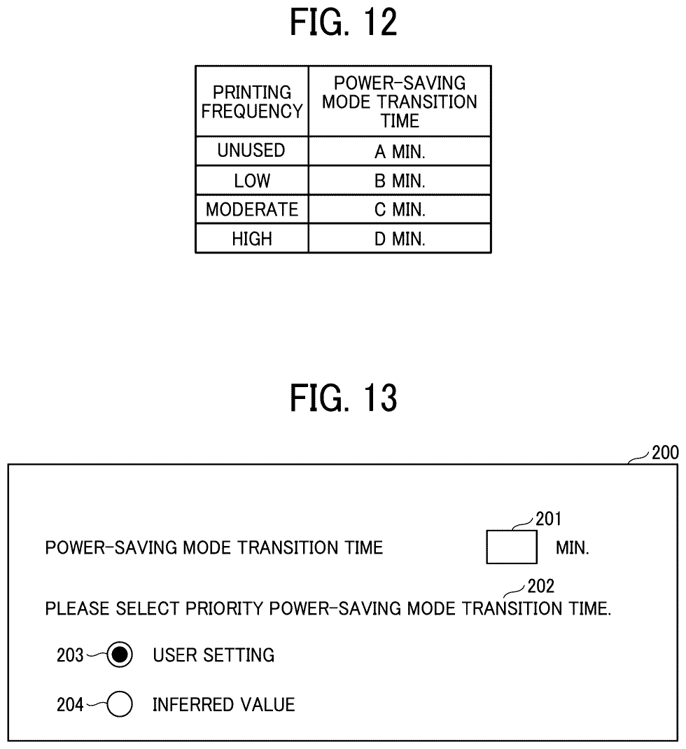

FIG. 12 illustrates a transition time determination table to which the transition time determination unit 417 refers. As illustrated in FIG. 12, the printing frequency and the power-saving mode transition time are associated with each other in advance. A, B, C, and D in the power-saving mode transition time follow the relationship A<B<C<D. The transition time determination unit 417 determines the power-saving mode transition time per hour based on the combined printing frequency.

### User-Configured Power-Saving Mode Transition Time

The user-configured power-saving mode transition time is described below with reference to FIG. 13.

FIG. 13 illustrates a transition time setting screen 200 displayed by the image forming apparatus 100. The transition time setting screen 200 includes a power-saving mode transition time setting field 201, a message 202 “Select a priority power-saving mode transition time,” and two radio buttons 203 and 204. The user can input the power-saving mode transition time desired by the user in the power-saving mode transition time setting field 201. The user can select whether to prioritize the user-configured power-saving mode transition time, which is the power-saving mode transition time set by the user, or the power-saving mode transition time transmitted by the machine learning server 102 by pressing the radio button 203 or 204.

### Generation of Usage Frequency Model 220

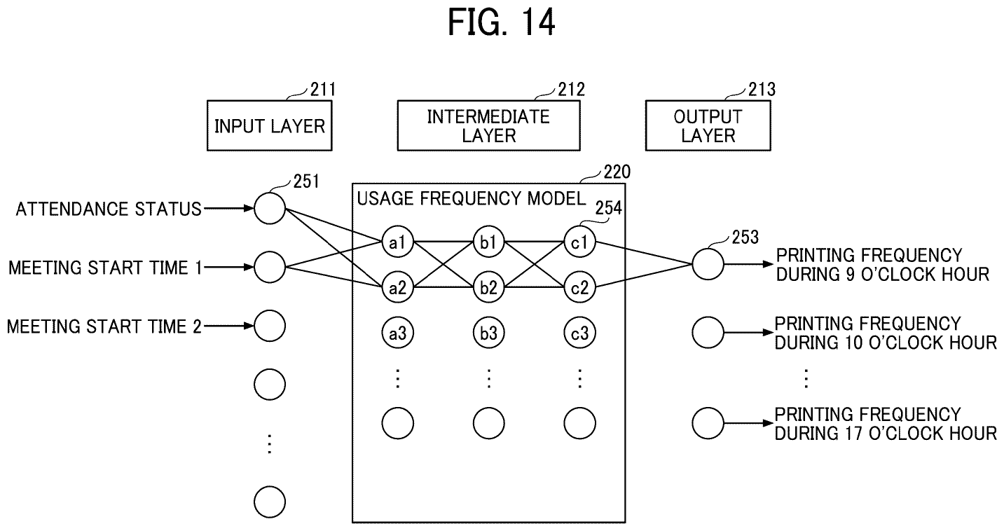

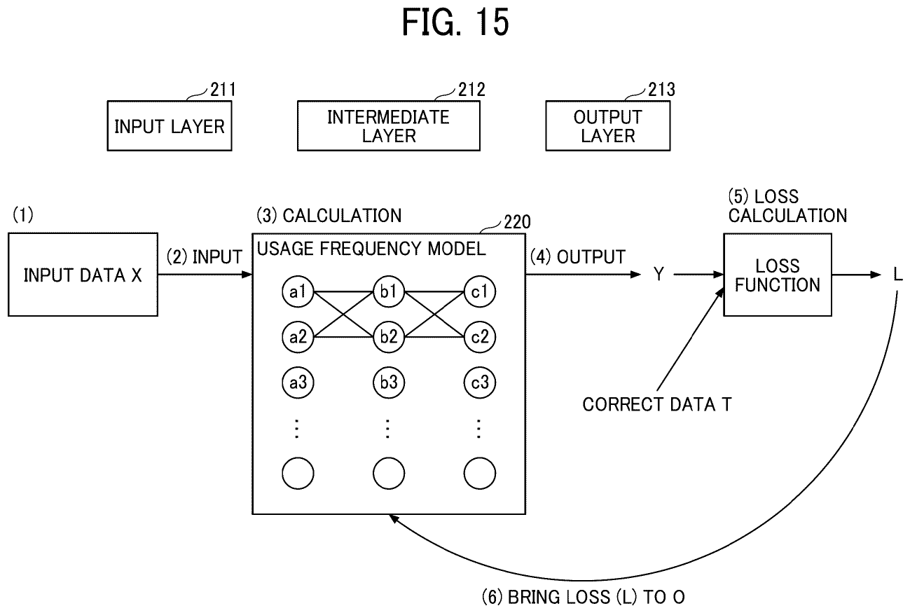

A method of generating the use frequency model 220 is described below with reference to FIGS. 14 and 15. FIG. 14 is a conceptual diagram of the usage frequency model 220 generated by the machine learning unit 414. FIG. 14 illustrates the usage frequency model 220 using a neural network. The neural network includes an input layer 211, an output layer 213, and one or more intermediate layers 212. The input layer 211 is provided with nodes 251 corresponding in number to the input data. The output layer 213 is provided with nodes 253 of the number of data to be output to the use frequency model 220. The number of intermediate layers 212 and the number of nodes 254 are designed as appropriate. The configuration of the neural network is substantially the same as that of the existing neural network, and thus the description thereof will be omitted.

The input data and the output data of the present embodiment are as follows.

Input data X indicates the attendance status and individual schedules of each employee. Output data Y indicates a printing frequency per hour.

The attendance status indicates whether the employee is at the office or workplace on a day when correct data is acquired. The correct data corresponds to output data in the learning data and is a printing frequency per hour acquired from the job log. The individual schedules include meeting schedules on a day when correct data is acquired and indicate the meeting start times. Since multiple meetings may be started a day, multiple nodes for the meeting start time are prepared in the input layer 211. A predetermined time such as 9:00 at which the image forming apparatus 100 is activated or returns from sleep every day is input into a node that is not used. This time is input because the image forming apparatus 100 is considered to be used.

Therefore, the number of nodes in the input layer 211 is considered to be about three.

The printing frequency is calculated from the printing time stored in the job log time recording unit 408. For example, the printing frequency of an employee who prints three times from 9:00 to 10:00 is 3. Therefore, the number of nodes of the output layer 213 is about nine from 9 o'clock hour to 17 o'clock hour.

During learning, correct data included in learning data is compared with the printing frequency per hour output from each node of the output layer 213. The printing frequency per hour is just one example. The printing frequency for periods such as every 30 minutes or every 2 hours may be learned.

FIG. 15 is a schematic diagram illustrating a learning method.
(1) As described above, learning data (input data X and correct data T) are prepared. The output data Y in the learning data is referred to as the correct data T.
(2) The input data X is input into the input layer 211.
(3) The input data X is transmitted through the neural network.
(4) The output layer 213 outputs the output data Y.
(5) The machine learning unit 414 inputs the output data Y and the correct data T into the loss function to calculate loss L. When the power-saving mode transition time for each period is a continuous value, the loss function is a square error function. The loss L is simply acquired by “the correct data T-the output data Y.”
(6) The machine learning unit 414 updates, for example, the coupling weighting coefficient between the nodes of the neural network to decrease the loss L toward 0. As a method of updating, for example, an error backpropagation method is known. The error backpropagation method is a method of adjusting, for example, a combination weighting coefficient between the nodes of each neural network to decrease the error.

By adjusting the combination weighting coefficient in the usage frequency model 220 so that the output data Y output when the input data X is input into the usage frequency model 220 (neural network) becomes as close to the correct value (correct data T) as possible, the usage frequency model 220 can output the output data Y with high accuracy with respect to the new input data X. In other words, when the learning of the usage frequency model 220 is completed, the usage frequency model 220 outputs the individual printing frequency per hour with respect to the input data (attendance status and individual schedules) from the output layer 213.

In FIGS. 14 and 15, the learning method has been described by taking the neural network as an example. However, specific algorithms of machine learning include deep learning, a nearest neighbor method, a naive Bayes method, a decision tree, and a support vector machine. Any available algorithm of the above may be used and applied to the present embodiment as appropriate.

### SPECIFIC EXAMPLES

The learning data is individual employee information such as attendance status, individual schedules including meeting schedules, and a printing time (printing frequency). The individual employee information is stored in the data server 105. For example, the attendance status is recorded through access control by timecard stamping or by holding an employee ID card (IC card) over the gate. The job log time recording unit 408 records job execution time such as printing time or copying time in association with an employee. When the printing time is recorded, the printing frequency per hour can be calculated. The data server 105 acquires the schedules of, for example, a meeting of each employee from the schedule management server.

Information that can be inferred by the usage frequency model 220 through learning is described below. The following is an example. The following may be applied as long as the individual employee information is learned, or there may be excess or deficiency. The usage frequency model 220 learns the employee information on Employee A and infers in what situation Employee A prints. Employee A may be referred to simply as “A” in the following description.

The usage frequency model 220 infers a printing frequency of “unused” when A is not at the office, based on the attendance status.

The usage frequency model 220 infers a high printing frequency immediately after the arrival at work (e.g., during the 9 o'clock hour) when A tends to always print on the first morning after arriving at work.

The usage frequency model 220 infers a high printing frequency during the period before a meeting when A tends to print materials before meetings. At the time of learning, the learning data generation unit 413 may compare the title of a printed material such as a document name with the individual schedules such as a meeting name and identify the printed material related to the meeting. The learning data generation unit 413 uses the printing time at which the printed material related to the meeting is printed as correct data. In this way, for example, only the printing frequency of printed materials related to the meeting can be inferred.

In addition, the machine learning unit 414 can learn not only the meeting but also individual action items and printing frequency from the data server 105. The usage frequency model 220 can infer when to print for the action items included in the individual schedules.

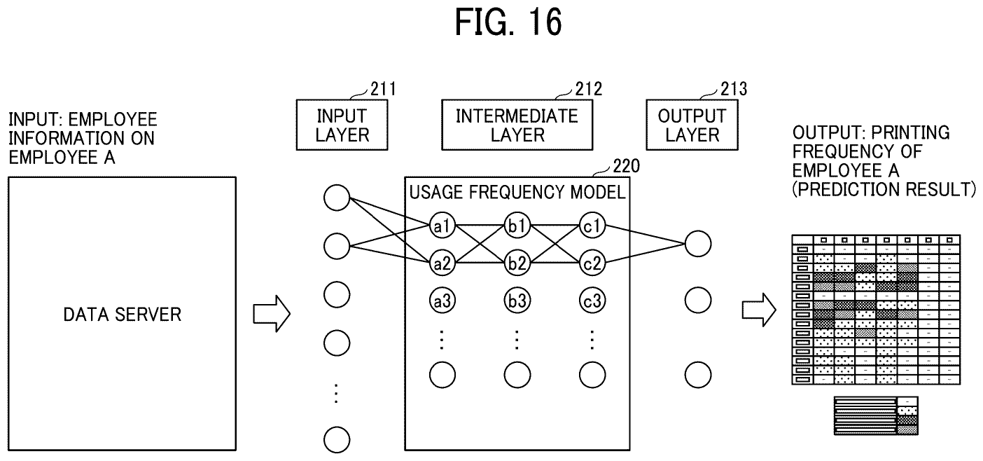

FIG. 16 is a schematic diagram illustrating inference by the usage frequency model 220. The machine learning unit 414 learns the employee information on A and generates the usage frequency model 220. The usage frequency model 220 infers the printing frequency per hour with the employee information on A as input data.

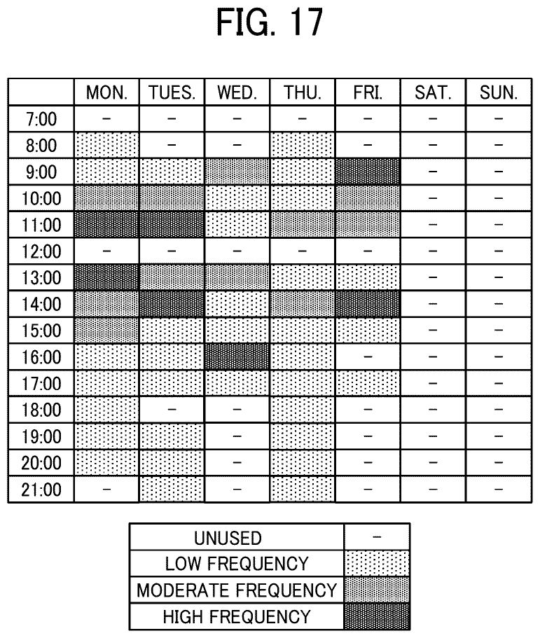

FIG. 17 illustrates a printing frequency inferred by the usage frequency model 220 for an employee. In FIG. 17, the printing frequency per hour is inferred from Monday to Friday. The usage frequency model 220 does not need to infer the printing frequency for one week all at once. The usage frequency model 220 may update the printing frequency on and after the current day each time new input data is acquired. As illustrated in FIG. 17, the usage frequency model 220 can infer the individual printing frequency by day of the week and by hour.

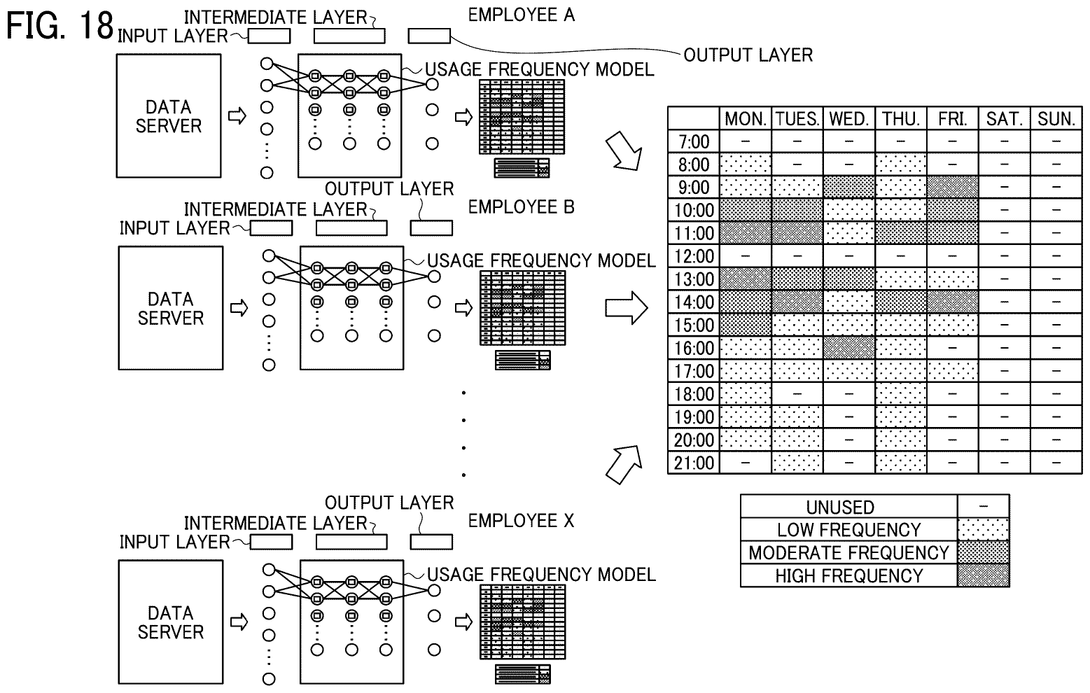

FIG. 18 is a diagram illustrating an operating frequency generated from printing frequencies inferred for multiple employees. The multiple employees refer to employees who share the single image forming apparatus 100. When generating learning data, the learning data generation unit 413 associates each employee with the image forming apparatus 100 they use. The operating frequency can be determined when the transition time determination unit 417 combines the printing frequencies of the multiple employees who use the same image forming apparatus 100.

As illustrated in FIG. 18, the usage frequency model 220 calculates the printing frequency from the employee information on each of, for example, Employees A to X. Employees A to X may be referred to simply as A to X in the following description. The usage frequency model 220 combines the printing frequencies inferred for each employee. Thus, the printing frequency as group data is acquired. For example, when the printing frequency is inferred such that A performs printing once, B performs printing once, and C performs printing once in a certain hour, the usage frequency model 220 sums the printing frequencies (1+1+1=3) and estimates the printing frequency in the hour to be three times.

In this way, the machine learning server 102 finally combines the printing frequencies inferred for the individuals to generate group data of the printing frequencies per hour and transmits the power-saving mode transition time acquired from the printing frequencies as the group data to the image forming apparatus 100. The image forming apparatus 100 performs the power-saving mode transition control based on the power-saving mode transition time. Thus, the optimum power-saving mode transition time can be set, and the total power consumption can be reduced.

### Operations or Processes

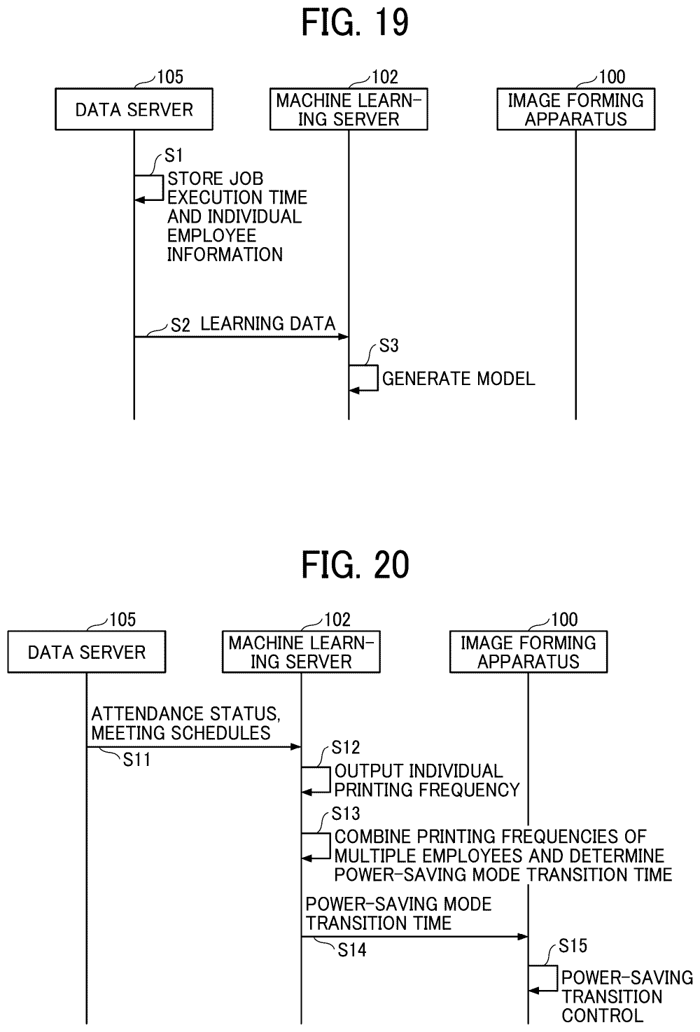

A process in which the apparatus system 1 generates the usage frequency model 220 is described below with reference to FIG. 19. FIG. 19 is a sequence diagram illustrating a process in which the apparatus system 1 generates the usage frequency model 220.

In step S1, the job log time recording unit 408 records job execution time in the data storage unit 412, and the data collection and provision unit 410 stores the individual employee information such as attendance status and individual schedules in the data storage unit 412.

In step S2, the data server 105 transmits, for example, the job execution time and individual employee information including attendance status and individual schedules such as meeting schedules to the machine learning server 102 as learning data.

In step S3, the machine learning server 102 receives the learning data. First, the learning data generation unit 413 converts the attendance status into “present” or “absent” and acquires the meeting start time from the individual schedules.

The meeting start time is the start time of a meeting on a day for which the printing frequency is to be inferred. The learning data generation unit 413 also converts the printing time into a printing frequency per hour. Since no printing time is recorded on a day on which the employee does not perform printing, the learning data generation unit 413 sets the printing frequency of the correct data to 0 (unused).

The machine learning unit 414 of the machine learning server 102 performs learning as described above with the individual employee information of the learning data as input data and the printing frequency per hour acquired from the learning data as correct data and generates the usage frequency model 220 that outputs the individual printing frequency per hour.

An overall process in which the machine learning server 102 outputs the power-saving mode transition time per hour using the usage frequency model 220 is described below with reference to FIG. 20. FIG. 20 is a sequence diagram illustrating a process in which the machine learning server 102 outputs the power-saving mode transition time per hour using the generated usage frequency model 220.

Generation of the usage frequency model 220 allows the inference unit 416 to output the individual printing frequency on the day using the usage frequency model 220 at the time when, for example, the attendance status is identified on the previous day or the day. Input data at the time of inference is the attendance status and a meeting start time on a day for which the printing frequency is to be inferred. For this reason, at a predetermined time such as the night of the previous day or the morning of the day, in step S11, the data server 105 transmits the individual attendance status and meeting schedules to the machine learning server 102. The individual attendance status may be attendance information acquired by timecard stamping or by holding an employee ID card over a gate or may be acquired from the schedule management server. The meeting schedules indicate the start time of each meeting scheduled on a day when the printing frequency is to be inferred.

In step S12, the inference unit 416 inputs the individual attendance status and the meeting start time into the usage frequency model 220 and infers the printing frequency per hour on a day (e.g., tomorrow or the day) on which the printing frequency is to be inferred. This printing frequency is a so-called predicted value.

In step S13, the transition time determination unit 417 combines the individual printing frequencies per hour of the employees sharing the image forming apparatus 100 and determines the power-saving mode transition time corresponding to the printing frequency per hour with reference to the transition time determination table.

In step S14, the machine learning server 102 transmits the power-saving mode transition time per hour to the image forming apparatus 100 as machine learning result data.

In step S15, the transition time setting unit 407 of the image forming apparatus 100 acquires the power-saving mode transition time from the machine learning server 102 and transmits the power-saving mode transition time to the power-saving control unit 405. The power-saving control unit 405 performs power-saving transition based on the power-saving mode transition time per hour.

The apparatus system 1 learns the usage frequency using AI based on individual employee information, instead of the group data acquired from multiple employees, to optimize the power-saving mode transition time and reduce the overall power consumption even in the remote work environment.

### Other Application Examples

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, although the machine learning server 102 includes the inference unit 416 and the transition time determination unit 417 in the embodiment described above, the image forming apparatus 100 may include the inference unit 416 and the transition time determination unit 417. In this case, the image forming apparatus 100 acquires the attendance status and meeting schedules from the data server 105 and infers the printing frequency.

Although the machine learning server 102 generates the usage frequency model 220 in the embodiment described above, the image forming apparatus 100 may generate the usage frequency model 220.

In the block diagram illustrating a configuration such as FIG. 11, the processing by the data server 105, the machine learning server 102, and the image forming apparatus 100 is divided into processing units (functional units) according to the main functions of the data server 105, the machine learning server 102, and the image forming apparatus 100 to facilitate understanding of the processing. The present disclosure is not limited by how the processing is divided or by the names of the processing units. The processing by the data server 105, the machine learning server 102, and the image forming apparatus 100 can be divided into more processing units according to the processing content. Also, a single processing unit can be divided to include more processing tasks.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a CD-ROM or DVD, and/or the memory of an FPGA or ASIC.

The present disclosure includes the following aspects.

According to a first aspect, in an apparatus system in which an information processing apparatus and an apparatus communicate with each other through a network, the information processing apparatus includes an inference unit and a transition time determination unit. The inference unit inputs user information on an individual user on a day on which a usage frequency of the apparatus by the user is to be inferred into a usage frequency model that has learned a correspondence between the user information and the usage frequency of the apparatus, to infer the usage frequency of the apparatus on the day. The transition time determination unit determines a power-saving mode transition time based on the usage frequency of the apparatus inferred by the inference unit. The apparatus includes a power-saving control unit that transitions to a power-saving mode when a time during which the apparatus is not used exceeds the power-saving mode transition time acquired from the information processing apparatus.

According to a second aspect, in the apparatus system of the first aspect, the user information includes an attendance status of the user and a meeting start time.

According to a third aspect, in the apparatus system of the first or second aspect, the inference unit infers the usage frequency of the apparatus per hour on the day.

According to a fourth aspect, in the apparatus system of any one of the first to third aspects, the inference unit infers individual usage frequencies of the apparatus for each of multiple users sharing the apparatus on the day based on the user information on each of the multiple users. The transition time determination unit combines the individual usage frequencies of the apparatus inferred for each of the multiple users to calculate an operating frequency of the apparatus by the multiple users.

According to a fifth aspect, in the apparatus system of the fourth aspect, the inference unit infers the usage frequency of the apparatus per hour on the day for each of the multiple users. The transition time determination unit calculates the usage frequency of the apparatus per hour by the multiple users and determines the power-saving mode transition time based on the operating frequency.

According to a sixth aspect, in the apparatus system of any one of the first to fifth aspects, the apparatus includes a setting receiving unit that receives a selection of whether to prioritize the power-saving mode transition time set by the user or the power-saving mode transition time acquired from the information processing apparatus. The power-saving control unit performs control to transition to power-saving mode based on the selection received by the setting receiving unit.

According to a seventh aspect, in the apparatus system of any one of the first to sixth aspects, the information processing apparatus includes a machine learning unit learns the correspondence between the user information on the individual user and the usage frequency of the apparatus by the user to generate the usage frequency model.

1. A system, comprising:
an information processing apparatus; and
an apparatus to communicate with the information processing apparatus through a network,
the information processing apparatus including circuitry configured to:
input user information on an individual user on a day on which a usage frequency of the apparatus by the user is to be inferred, into a usage frequency model that has learned a correspondence between the user information and the usage frequency of the apparatus, to infer the usage frequency of the apparatus on the day; and
determine a power-saving mode transition time based on the inferred usage frequency of the apparatus,
the apparatus including another circuitry configured to transition to a power-saving mode when a time during which the apparatus is not used exceeds the power-saving mode transition time acquired from the information processing apparatus.

2. The system according to claim 1,
wherein the user information includes an attendance status of the user and a meeting start time.

3. The system according to claim 1,
wherein the circuitry of the information processing apparatus is configured to infer the usage frequency of the apparatus per hour on the day.

4. The system according to claim 1,
wherein the circuitry of the information processing apparatus is configured to:
infer individual usage frequencies of the apparatus for each of a plurality of users sharing the apparatus on the day based on the user information on each of the plurality of users; and
combine the individual usage frequencies of the apparatus inferred for each of the plurality of users to calculate an operating frequency of the apparatus by the plurality of users.

5. The system according to claim 4,
wherein the circuitry of the information processing apparatus is configured to:
infer the usage frequency of the apparatus per hour on the day for each of the plurality of users;
calculate the usage frequency of the apparatus per hour by the plurality of users; and
determine the power-saving mode transition time based on the operating frequency.

6. The system according to claim 1,
wherein said another circuitry of the apparatus is further configured to:
receive a selection of whether to prioritize the power-saving mode transition time set by the user or the power-saving mode transition time acquired from the information processing apparatus; and
perform control to transition to the power-saving mode based on the received selection.

7. The system according to claim 1,
wherein the circuitry of the information processing apparatus is further configured to learn the correspondence between the user information on the individual user and the usage frequency of the apparatus by the user to generate the usage frequency model.

8. A control method, comprising:
inputting user information on an individual user on a day on which a usage frequency of an apparatus by the user is to be inferred into a usage frequency model that has learned a correspondence between the user information and the usage frequency of the apparatus, to infer the usage frequency of the apparatus on the day, the apparatus communicating with an information processing apparatus through a network; and
determining a power-saving mode transition time based on the inferred usage frequency of the apparatus, the apparatus transitioning to a power-saving mode when a time during which the apparatus is not used exceeds the power-saving mode transition time acquired from the information processing apparatus.

9. A non-transitory recording medium storing a plurality of instructions which, when executed by one or more processors of an information processing apparatus, causes the one or more processors to perform a method, the method comprising:
inputting user information on an individual user on a day on which a usage frequency of an apparatus by the user is to be inferred into a usage frequency model that has learned a correspondence between the user information and the usage frequency of the apparatus, to infer the usage frequency of the apparatus on the day, the apparatus communicating with the information processing apparatus through a network; and
determining a power-saving mode transition time based on the inferred usage frequency of the apparatus, the apparatus transitioning to a power-saving mode when a time during which the apparatus is not used exceeds the power-saving mode transition time acquired from the information processing apparatus.
